(19) United States
(12) Patent Application Publication
(10) Pub. No.: US 2007/0021847 A1
(43) Pub. Date: Jan. 25, 2007

(54) Distributed control system

(76) Inventors: Akihiko Hyodo, Hachioji (JP); Naoki Kato, Kodaira (JP); Fumio Arakawa, Kodaira (JP)

Correspondence Address: Stanley P. Fisher;REED SMITH LLP, Suite 1400, 3110 Fairview Park Drive, Falls Church, VA, 22042-4503, US

(21) Appl. No.: 11/354,072

(22) Filed: Feb. 15, 2006

(30) Foreign Application Priority Data
Jul. 22, 2005 (JP) 2005-212238

(51) Int. Cl. G05B 11/01

(52) U.S. Cl. 700/20; 700/19

(57) ABSTRACT

A distributed control system having a plurality of network-connected control units is realized in which a task having characteristics specific to a controller, such as input/output processing being necessary, or data stored in a dedicated controller having to be used, can be transferred to another controller for execution. In order to transfer a task specific to a controller to another controller for execution, a transfer source controller is provided with, in addition to an original function, a function of collecting input data of a storage area and context information and transferring them to a transfer destination controller. The destination controller has a function of storing the data transferred from the source controller in a storage area, making arithmetic operations, and sending the arithmetic result to the source controller. An arithmetic operation program is provided for both the source and destination controllers. The destination controller determines a reference address by a method appropriate for task processing.

### CLAIM OF PRIORITY

The present application claims priority from Japanese application JP 2005-212238 filed on Jul. 22, 2005, the content of which is hereby incorporated by reference into this application.

### FIELD OF THE INVENTION

The present invention relates to a distributed control system having a plurality of network-connected control units each for executing a program designed to control each of plural plants. More particularly, the invention relates to a distributed control system capable of executing the tasks, represented by vehicle control, that require very stringent real-time processing.

### BACKGROUND OF THE INVENTION

In recent years, control by a control system for a motor vehicle or the like is being more advanced to improve safety, amenity/comfortableness, and environments, and the number of electronic control units (ECUs) mounted in the vehicle is on the increase. In vehicle-mounted electronic control systems, each ECU generates control signals from the information input from a sensor or the like, and outputs the control signals to an actuator. The actuator operates in accordance with the control signals. Each ECU is connected via an automotive LAN to construct a communications network, and conducts data sharing and operational interlinking to implement advanced coordination control.

In such an electronic control system with network-connected ECUs, each ECU is constructed so as to execute only a specific control program, and requires processing performance high enough to respond to the maximum workload applied. There is a problem, however, in that if the plant to be controlled does not operate or if sophisticated control is not required, total system operational efficiency decreases since the throughput of the ECU is not fully utilized.

Accordingly, a technique is proposed that distributes a processing workload among a plurality of ECUs to utilize the excess capabilities of each ECU. For example, according to Japanese Patent Laid-open No. 2004-38766, entitled “Automotive Communications System” (hereinafter, referred to as Patent Reference 1), the control programs required for control of various plants to be controlled are divided into plant-specific tasks that are to be executed for each ECU connected to a network, and floating tasks each executable using any such ECU, and programs for executing the floating tasks are managed using a network-connected manager ECU to enhance total ECU availability for effective use of each ECU's resources.

(Patent Reference 1: Japanese Patent Laid-open No. 2004-38766)

### SUMMARY OF THE INVENTION

For the technique disclosed in Patent Reference 1, the tasks to be transferred are confined to the floating tasks each executable using any ECU. In automobile control, processing with individual control units generally accounts for a large majority of workloads, so if tasks whose locality is confined as in Patent Reference 1 are excluded from workload distribution, the number of tasks usable for workload distribution will decrease. Only a very confined workload distribution effect is anticipated as a result.

An object of the present invention is to realize a distributed control system having a plurality of electronic control units (ECUs) connected via a network, in which system, tasks with such ECU-specific characteristics as including input/output processes and using the data stored within each ECU, can be transferred to and executed on any other of the ECUs.

In order to achieve the above object, the present invention endows each ECU with new functions for at least transferring a characteristic task of the ECU. When a transfer source ECU is defined as an ECU 1, a transfer destination ECU as an ECU 2, and a task that is characteristic of the ECU 1 and transferable therefrom to the ECU 2, as a task TA, the ECU 1 is endowed with the functions described below.

First, the ECU 1 originally has three functions: (1) acquiring the input data required for execution of the task TA, from a sensor connected to the ECU 1, and then storing the data into a random-access memory (RAM), (2) arithmetically processing the task TA using the input data stored within the RAM, and (3) transmitting arithmetic processing results on the task TA to an actuator connected to the ECU 1.

In addition to the above three original functions, the ECU 1 is endowed with two new functions for requesting the ECU 2 to process the task and using the processing results received from the ECU 2: (4) collecting from the RAM the input data required for arithmetic processing of the task TA, inclusive of the data that has been stored into the RAM by above function (1), and then if internal context information of the general-purpose register, control register, and/or the like contained in the ECU 1, is further necessary, transferring the collected input data and the RAM-stored data, inclusive of the context information, and (5) receiving result data on the task that has been transferred to the ECU 2, and then transmitting the result data to the actuator, or if necessary, storing the result data into the RAM of the ECU 1.

As with the ECU 1, the ECU 2 has functions equivalent to above functions (1) to (3), and is endowed with three new functions: (6) storing the input data of the task TA that has been transmitted from the ECU 1, into a RAM of the ECU 2, (7) arithmetically processing the task TA using the input data stored within the RAM, and storing the input data thereinto, and (8) collecting RAM-stored arithmetic processing results and transmitting the results to the ECU 1.

According to the present invention, a high workload distribution effect unachievable in a conventional control system can be obtained since the characteristic tasks of individual control units that generally account for a large portion of a processing workload can be transferred and executed.

### BRIEF DESCRIPTION OF THE DRAWINGS

FIG. 1 is a diagram that shows a first embodiment of a distributed control system having an ECU 2 in which a task with a changed memory reference destination is stored;

FIG. 2 is a diagram that shows data flow during task transfer and execution via data transport programs in the first embodiment;

FIG. 3 is a diagram showing the difference in memory reference address during task execution in the first embodiment;

FIG. 4 is a diagram that shows a distributed control system with programs stored in the task configuration where the process that requires access to an I/O area is separated;

FIG. 5 is a diagram that illustrates memory access associated with task execution by an ECU 1 in a second embodiment of a distributed control system;

FIG. 6 is a diagram that illustrates memory access associated with task execution by an ECU 2 in the second embodiment of a distributed control system;

FIG. 7 is a diagram showing a distributed control system which views an address translation table and executes a transferred task in a third embodiment;

FIG. 8 is a diagram showing a distributed control system which has a CPU workload monitor and a task transfer destination ECU table in a fourth embodiment;

FIG. 9 is a diagram that shows a task execution workload distribution flow in the fourth embodiment; and

FIG. 10 is a diagram showing a distributed control system which activates a communications module during program execution in a fifth embodiment.

### DETAILED DESCRIPTION OF THE PREFERRED EMBODIMENTS

When either the ECU 1 or the ECU 2 requests the other of the two ECU 2 to process a task on the presupposition that both ECUs have respective original tasks, the request may encompass not only data of the task whose processing is requested, but also a program of the task. The present invention assumes that the task whose processing is to be requested between the ECUs 1 and 2 is predefined, that both ECUs have the program of the task, and that when processing is requested, related data needs only to be transferred.

If the ECU 1 makes the request to the ECU 2, therefore, a program that has been converted into a form convenient for executing arithmetic processing of the task TA is prestored within the ECU 2. In closer perspective, however, the form of this prestored program may differ from that of the program prestored within the ECU 1.

More specifically, an address of a reference destination in a memory area may differ between the prestored program of the ECU 1 and that of the ECU 2. Alternatively, a program with the same reference destination address as that of the program within the ECU 1 may also be stored into the ECU 2 and hardware for correcting an address of memory access of a central processing unit (CPU) using an address translation table, for example, may be added to enable sequential access to appropriate data.

Accordingly, it is also a preferred method to provide an internal CPU of the ECU 2 with a mode for direct memory access and a mode for address correction via the address translation table, and if a task to be executed is the task whose processing has been requested, execute the task in the address correction mode.

The input data and output data relating to the task whose processing has been requested can be transported in the lump when all data is ready, or transported independently for each set of data, or transported repeatedly in certain volumes of data.

When the task TA is executed on the ECU 1, this task can be processed using the foregoing functions (1), (2), and (3), in that order, and this flow of processing is called processing mode 1. When the task TA is executed on a processing request basis, this task can be processed using the foregoing functions (1), (4), (6), (7), (8), (5), and (3), in that order, and this flow of processing is called processing mode 2. The ECU 1, when it activates the task TA, can select which of the two processing modes is to be used to execute the task. Basically, however, the ECU 1 selects processing mode 1 to process the task TA. When the ECU 1 does this, however, a deadline for the execution of the task may not be strictly observed, so if this is likely to happen, the ECU 1 selects processing mode 2 and requests the ECU 2 to process the task. Functions (1) to (8) and the two processing modes enable each ECU to execute its characteristic task on the other ECU and thus a high load distribution effect to be obtained.

### First Embodiment

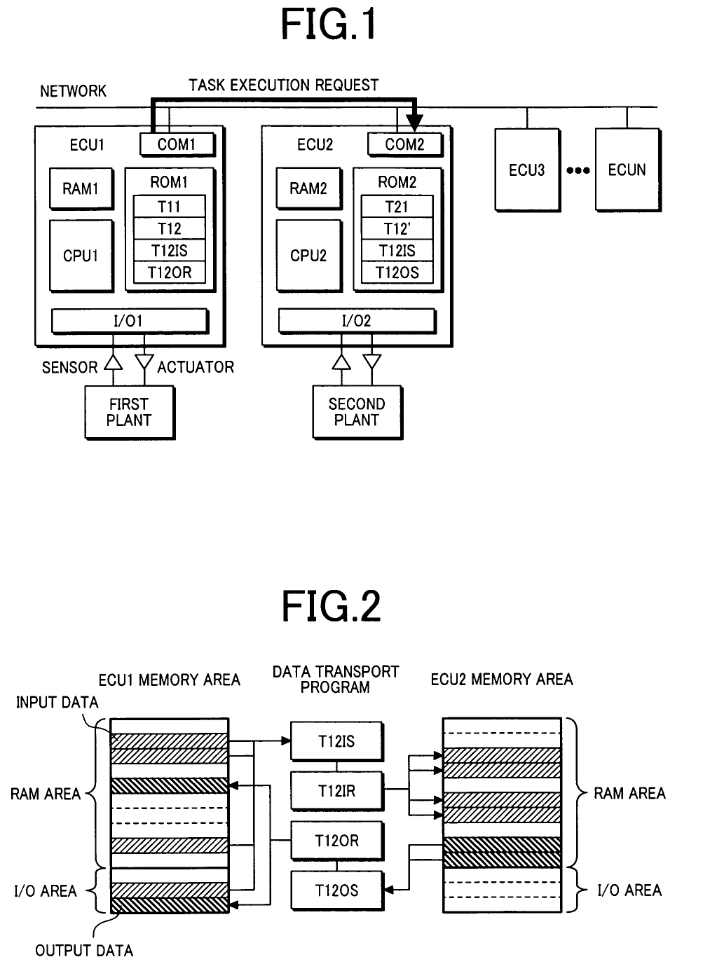

FIG. 1 is a total block diagram of a distributed control system according to a first embodiment with an N number of electronic control units (ECUs) 1 to N connected to a network. Each ECU includes memory devices such as a read-only memory (ROM) and a RAM, a CPU that performs arithmetic operations, an input/output (I/O) device, and a communications (COM) device.

The ROM 1 of the ECU 1 contains a task T11 that only the ECU 1 can execute, and a task T12 that the ECU 1 itself or the ECU 2 when requested therefrom can execute. The ROM 1 of the ECU 1 also contains T12IS and T12OR programs concerned with the input/output data transport conducted when the T12 is transferred for execution. The T12IS program collects the input data required for arithmetic processing of the T12, from a sensor connected to the ECU 1, or from the ROM 1 or a RAM 1, and delivers the data to a communications device COM 1. The T12OR program writes into an input/output device I/O 1 or stores into the RAM 1 the data returned as arithmetic results from the ECU 2 after task transfer thereto. These T12IS and T12OR programs can be handled as tasks or as the processes undertaken by an operating system (OS).

The ROM 2 of the ECU 2 contains a task T21 that only the ECU 2 can execute, and a task T12′ that the ECU 2 can execute when requested from the ECU 1. The task T12 stored within the ROM 1 of the ECU 1, and the task T12′ stored within the ROM 2 of the ECU 2 are the same in the type and details of arithmetic processing. However, both tasks differ in the memory address referred to during computing. This is why the latter task is named with an apostrophe (′). The T12 and T12′ tasks, when incompatible between CPUs 1 and 2, are naturally binary-coded. In addition, even when different arithmetic processing algorithms are used between the T12 and the T12′, there is no problem if output result data agrees with each other between both. The ROM 2 of the ECU 2 also contains T12IR and T12OS programs concerned with the input/output data transport conducted when the T12 task of the ECU 1 is transferred for execution. The T12IR program receives the input data required for arithmetic processing of the T12, from a communications device COM 2 that has received data from the ECU 1, and stores the input data into a RAM 2. The T12OS program collects arithmetic processing result data of the T12′ task from the RAM 2 and delivers the data to the communications device COM 2. These T12IR and T12OS programs can be handled as tasks or as the processes undertaken by the OS. In addition, each ECU retains, as a table not shown, information on a transferable task and on the ECU to which the task is to be transferred. Process flow of task T11 execution is described below as an example of a normal task execution procedure.

First, the task T11 is activated by the occurrence of a signal such as a timer interrupt. The ECU 1 then receives the input data required for arithmetic processing of the task T11, from the sensor connected to the ECU 1, through I/O 1. Next in accordance with the program procedure laid down in the task T11, the ECU 1 activates the CPU 1 to perform arithmetic operations using the input data sent from the sensor, the data stored within the ROM 1 or RAM 1, and/or other data, and generates a signal to control a first control object (plant). During execution of this procedure, if necessary, the ECU 1 exchanges data with other ECUs from COM 1 through the network. After this, the ECU 1 outputs the control signal to an actuator through the input/output device I/O 1, thus controlling the first plant to be controlled.

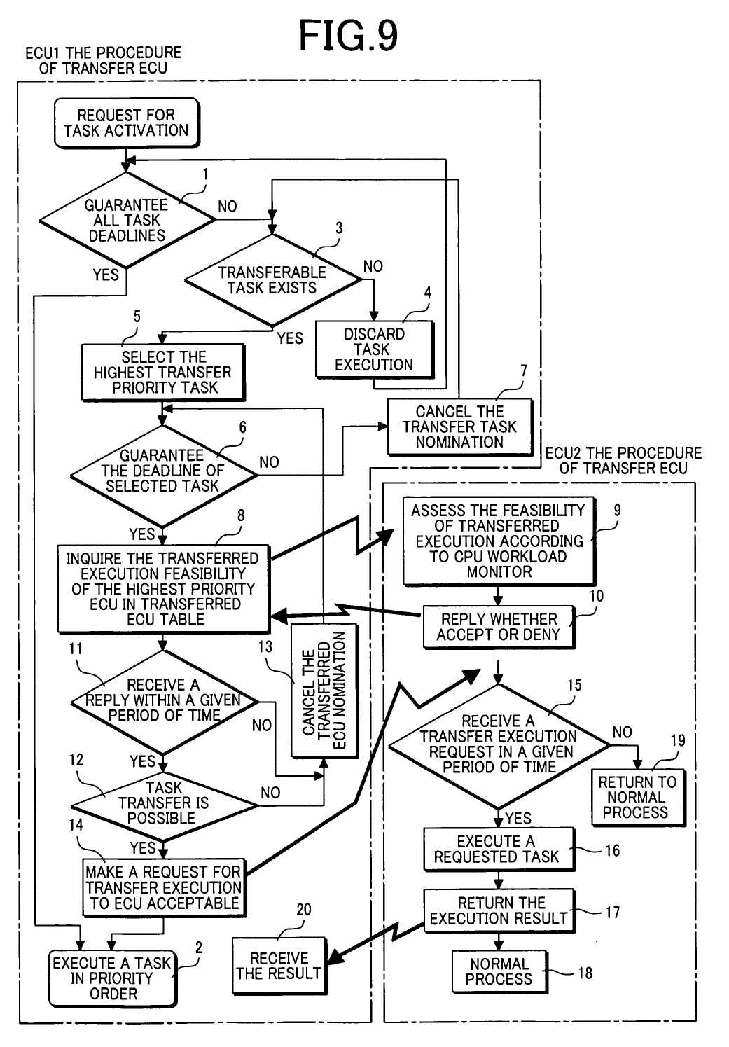

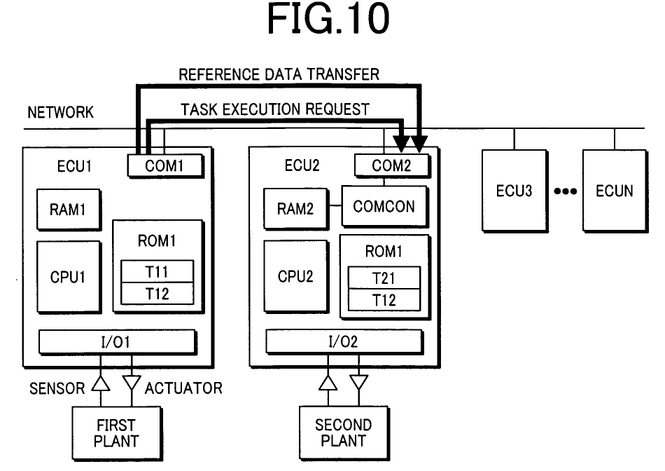

It is possible to select whether the task T12 is to be directly executed on the ECU 1 or to be transferred to the ECU 2 and executed thereon. There is a need, therefore, to select either of these execution methods when an activation request occurs. A criterion for the selection is basically whether a deadline for the execution of the task T12 can be strictly observed when the task is executed on the ECU 1. This criterion will be described later with reference to FIG. 9. When the execution method with the ECU 1 is selected, the task is processed using the same procedure as that mentioned above for executing the task T11. An execution procedure to be used when the method of transferring the task T12 to the ECU 2 and executing the task thereon is selected is described below using FIG. 2.

FIG. 2 shows how input/output data is exchanged during task transfer and execution via the T12IS and T12OR programs within the ROM 1 of the ECU 1 and the TS121R and T12OS programs within the ROM 2 of the ECU 2. After activation of the task T12, when the method of transferring the task T12 to the ECU 2 and executing the task thereon is selected, the T12IS program is executed first. The T12IS program collects the sensor input data required for arithmetic processing of the T12, and the data contained in the ROM 1 or the RAM 1, and delivers both types of data to the communications device COM 1. Packets that collected input data are delivered from the communications device COM 1 through the network to the communications device COM 2.

The T12IR program is activated by the occurrence of a communications interrupt. The T12IR program receives input data packets from the communications device COM 2 and stores the input data into a predetermined address or an address determined during execution of the program when an unoccupied area in the RAM 2 is reserved. Arithmetic processing of the task T12′ can be started either when the task is activated following storage of all input data into the RAM 2, or concurrently with input data storage after the task has been activated by the occurrence of a communications interrupt during input data packet receiving. After or during arithmetic processing of the task T12′, part of result data is stored into the RAM 2. The T12IS program is then activated to collect arithmetic processing result data of the task T12′ from the RAM 2 and deliver the data as output data packets to the communications device COM 2.

These output data packets are transmitted from the communications device COM 2 to the communications device COM 1 of the ECU 1 through the network, and the T12OR program is activated by the occurrence of a communications interrupt. The T12OR program receives the output data packets from the communications device COM 1 and outputs a control signal to the actuator through the input/output device I/O 1. At this time, if necessary, part of the output data is also stored into the RAM 1. The task T12 is transferred and executed using this procedure.

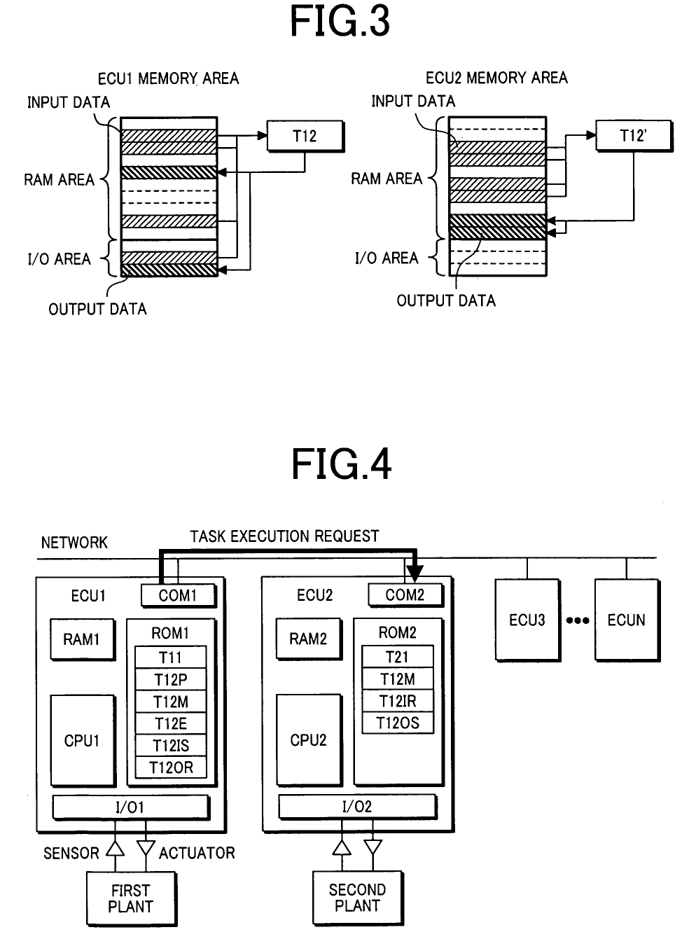

FIG. 3 shows the difference in memory reference destination address between the tasks T12 and T12′ when these tasks are executed in the example of FIG. 2 that shows data storage by the input/output data transport programs T12IR, T12IS, T12OS, T12OR. The address referred to by the task T12′ does not need to be defined as an absolute address beforehand. Instead, a relative address may be defined and then a memory area that the T12IR program is to use may be determined during the execution thereof so as to be notified to the task T12′.

### Second Embodiment

Next, focusing on differences from the first embodiment, a description of a second embodiment of a distributed control system according to the present invention will be given using FIGS. 4, 5, and 6.

In FIG. 4, the task T12 of the ECU 1 in the first embodiment is substituted by three program processes, namely, tasks T12P, T12M, T12E. Although the T12P and T12E program processes are called tasks here, including these processes in OS processing of the ECU 1 does not pose problems, because the processes are performed to move internally stored data to required new addresses as the task T12 proceeds. The task T12P moves, from an I/O area into a RAM area, all input data, such as sensor input data, that is required for processing of the task T12. The task T12M obtains input data from the RAM, arithmetically processes the data, and stores output data into the RAM. The task T12E moves stored output data from the RAM area into the I/O area in order to output the data to the actuator or the like. In accordance with this procedure, the task T12 is executed on the ECU 1.

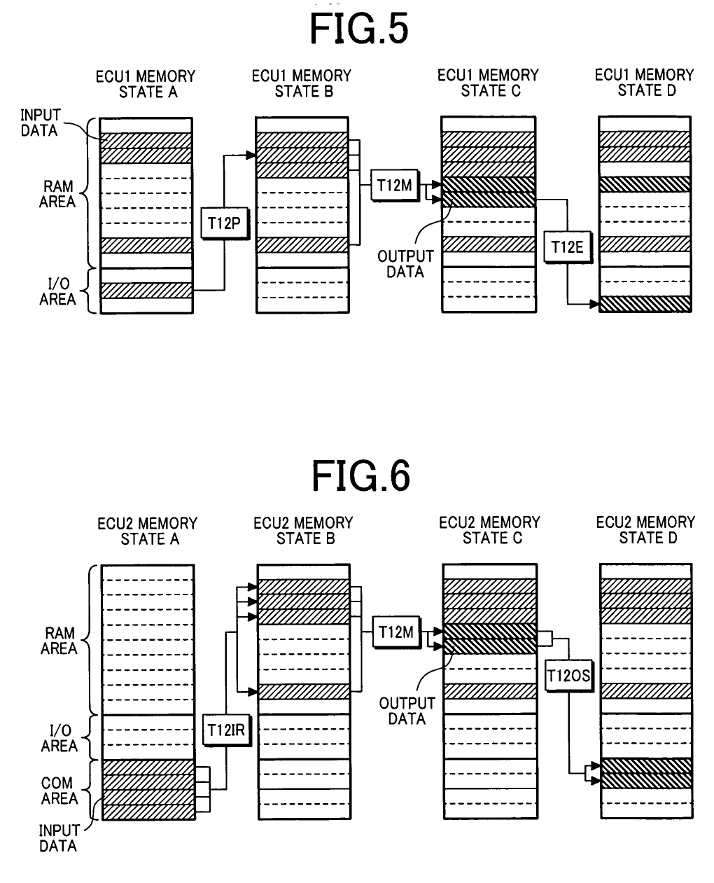

FIG. 5 illustrates memory access associated with the execution of the above task on the ECU 1, and memory states in the memory area of the ECU 1 after the memory access. Memory state A of the ECU 1 denotes a memory state within a memory area of the ECU 1 before the task T12 is activated. In FIG. 5, input data is stored in three sub-areas of the RAM area and new input data is stored in the I/O area. As the task T12 is activated, the task T12P moves all input data denoted as memory state A of the ECU 1, from the I/O area to the RAM area, and consequently, all input data is stored into the RAM area. This state is denoted as memory state B of the ECU 1. The task T12M obtains all input data denoted as memory state B of the ECU 1, from the RAM area, arithmetically processes the input data, and stores output data into two sub-areas of the RAM area. At this time, the output data is, of course, saved in the sub-areas that do not affect existing input data. That state is denoted as memory state C of the ECU 1. Of the two sets of output data that have been stored into the RAM area, only data to be output to an actuator or to the like is moved to an I/O area by the task T12E. Memory state D of the ECU 1 denotes the memory state within the memory area existing after the task T12 has been processed.

In the second embodiment, however, when the ECU 2 executes the task T12 of the ECU 1, only the task T12M within the ECU 1 is stored instead of the task T12. When task execution is requested from the ECU 1 to the ECU 2, input data that was collected into the RAM area of the ECU 1 is rearranged into a packet format inside a communications device COM 1 and then delivered to a communications device COM 2 of the ECU 2 through a network. FIG. 6 illustrates memory access associated with the execution of the above task on the ECU 2, and memory states in the memory area of the ECU 2 after the memory access.

Memory state A of the ECU 2 denotes a memory state of the input data for the task T12 of the ECU 1 when the data is stored in a communications device COM area. The T12IR program of the ECU 2 moves stored input data from the COM area into the RAM area so that the memory address referred to by the task T12M will be effective. Therefore, unlike the first embodiment in which the memory address referred to by the task T12′ needs to be corrected, the second embodiment requires no such correction of the memory address referred to. The task T12M obtains all input data denoted as memory state B of the ECU 2, from the RAM area, arithmetically processes the input data, and stores output data into two sub-areas of the RAM area. At this time, the output data is, of course, saved in the sub-areas that do not affect existing input data. That state is denoted as memory state C of the ECU 2. The task T12OS Of the ECU 2 moves the two sets of stored output data from the RAM area to the COM area in order to prepare for transfer to the ECU 1. Memory state D of the ECU 2 denotes a memory state within the memory area existing after the task T12 has been processed.

Output data that has been stored into the COM area is passed through the ECU 2, the network, and the ECU 1, in that order, and delivered to the communications device COM 1.

In the second embodiment, the T12IR and T12OS programs can be set so that the T12M program for arithmetic processing of the task T12 can maintain the memory address to which the T12M program itself refers. Accordingly, the second embodiment has an advantage that since a program of a common task T12 can be used at a plurality of transfer destination ECUs, the T12M program can be easily implemented.

### Third Embodiment

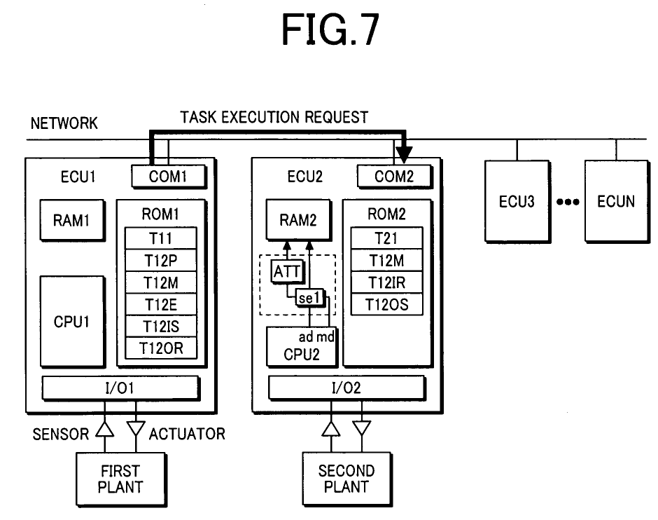

Next, focusing on differences from the second embodiment, a description of a third embodiment of a distributed control system according to the present invention will be given using FIG. 7.

In the third embodiment, when a CPU of an ECU 2 accesses a memory area of a RAM or the like, the CPU is adapted to allow a selector circuit (“sel”) to be used to conduct the access via an address translation table (ATT) or directly. In FIG. 7, symbol “ad” denotes an address signal that is output from the CPU, and symbol “md” an access mode selection signal.

The second embodiment has assumed that at the transfer destination ECU 2, the task T12M can use the reference destination address when the requesting ECU 1 executes the task T12. For that reason, although the second embodiment has the advantage of easy hardware implementation, there is a need for the ECU 2, whenever requested, to open a memory area to which the task T12M will refer, or to reserve an unoccupied memory area on the presupposition that the ECU 2 will be requested. Opening a memory area with each request will deteriorate original task-processing efficiency of the ECU 2, and leaving a memory area unoccupied will deteriorate memory availability.

Therefore, when the ECU 2 has a margin on its total processing schedule and allows a required memory area to remain unoccupied in provision for the task T12 requested, the memory area is directly accessed as in the second embodiment. The ECU 2 may not have a sufficient margin to leave the required memory area unoccupied. In such a case, during processing of the requested task T12, the ECU 2 translates an address of memory access into a reference destination memory area address using the address translation table (ATT) in order to conduct the access.

A way to use the address translation table (ATT) to correct the address can be determined fixedly or rendered rewritable during operation. Using the address correction function with the address translation table also provides an advantage in that flexibility is given to determination of the address referred to by a control program of the ECU 2.

### Fourth Embodiment

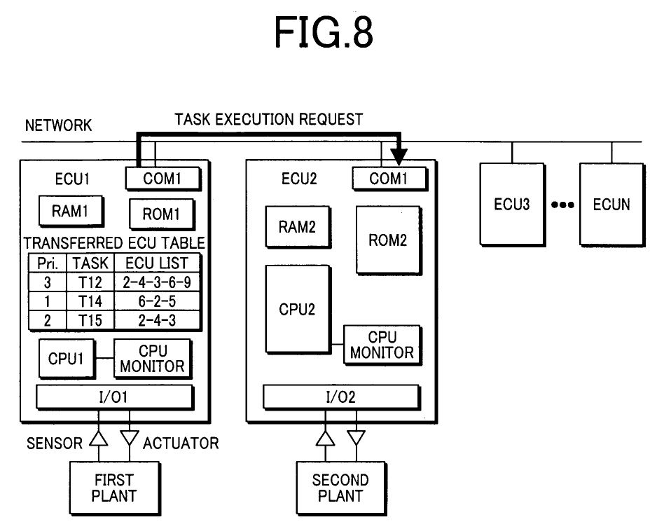

Next, a fourth embodiment of a distributed control system according to the present invention will be described below using FIGS. 8 and 9.

As shown in FIG. 8, an ECU 1 in the fourth embodiment has a CPU monitor and a task transfer destination ECU table. Transferable tasks are listed in this table, and information on priority for transfer and information on the transfer destination ECUs arranged in order of priority are registered in the table. The CPU monitor of the ECU 1 monitors a workload of its own CPU, and if the CPU workload exceeds a previously set threshold, the ECU 1 can start to transfer a task. The task transfer destination ECU table makes more efficient workload distribution possible in the present embodiment. In the present embodiment, an ECU 2 also has a CPU monitor. This enables the ECU 2 to determine from its CPU workload monitoring results whether a task transfer and execution request from the ECU 1 is to be accepted.

FIG. 9 shows a successive flow of process steps from the occurrence of a task activation request to task execution based on workload distribution. After a task activation request has occurred in the ECU 1, the ECU 1 conducts step 1 to judge whether the ECU can complete task execution in such a way as to strictly observe deadlines for execution of all executable tasks. In step 2, if possible, the ECU 1 executes tasks in the previously registered order of priority. If this is judged to be impossible, the ECU 1 conducts step 3 to examine whether the executable tasks include ones whose execution can be requested to other ECUs. In step 4, the ECU 1 discards task execution if there are no tasks whose execution can be requested to other ECUs. The task execution here means, for example, deleting the task of the lowest execution priority from all executable tasks. After discarding the task execution, the ECU 1 returns to step 1 to judge whether all the remaining tasks in an executable state can be executed to completion no later than the respective deadlines. This procedure is continued until such a form of task execution has been judged to be possible.

Next, in step 5, if one task only is present that can be executed on any other ECU, that task is selected, or if two or more such tasks exist, the task transfer destination ECU table that the ECU 1 possesses is viewed and the task with the highest execution priority is selected. The ECU 1 then judges in step 6 whether the selected task, when its processing is requested to the ECU 2, can be executed to completion no later than its time deadline. The judgment is based on an execution time of the task, a data transfer time thereof, and other information given beforehand. If the execution of the selected task within the required time is judged to be impossible, nomination of this task is canceled in step 7. After this, the ECU 1 returns to step 3 to check for other executable tasks and repeats the same procedure. If the execution of the selected task within the required time is judged to be possible, the ECU 1 proceeds to step 8 to view the task transfer destination ECU table and inquire of the highest-priority transfer destination ECU about whether the execution of the task can be completed within the required time.

In step 9, the ECU that has received the above inquiry refers to the workload monitor of the ECU's own CPU or to previously given information on the corresponding task and judges whether the execution request can be accepted. The ECU sends judgment results as a reply to the request source ECU in step 10.

In step 11, the ECU 1 that has inquired of the ECU 2 about whether the task can be completed within the required time waits for a preset time for the reply from the ECU 2. If the reply is not made within the preset time or if, in step 12, the reply itself is made but the execution request is judged to be unacceptable, the ECU 1 excludes the ECU 2 from a list of transfer destination ECUs in step 13. After this, the ECU 1 re-judges in step 6 whether completion of the selected task within the deadline can be guaranteed, and repeats the above procedure. If the ECU 2 replies that it can accept the request, the ECU 1 actually transmits the task execution request to the ECU 2 in step 14. The transmission is followed by the execution of the remaining tasks.

After replying that it can accept the request, the ECU 2 waits for a fixed time for an execution request from the ECU 1 in step 15. If the execution request is made within the fixed time, the ECU 2 proceeds to step 16 to execute requested processing of the task. Next, in step 17, the ECU 2 sends result data as a reply to the ECU 1 and in step 18, returns to normal operational sequence. If the execution request is not made within the fixed time, the ECU 2 directly returns to its normal operational sequence, as step 19.

After receiving result data as the reply from the ECU 2, the ECU 1 executes result data processing in step 20. If no result data is received from the ECU 2 within a fixed time, the ECU 1 discards the task execution, instead of executing result data processing, in step 20.

### Fifth Embodiment

Next, a fifth embodiment of a distributed control system according to the present invention will be described below using FIG. 10.

In the fifth embodiment, an ECU 2 possesses the same program as that of the task T12 stored within an ECU 1 for control items thereof. When requested from the ECU 1 to execute the task T12, the ECU 2 executes the task T12 stored within a memory area of the ECU's own memory device. To obtain data for executing the task T12, the ECU 2 sends a data transfer request to the ECU 1 via a communications activation device (COMCON) and receives the data transferred from a memory area of the ECU 1. In addition, since arithmetic results are stored into a memory device address of the ECU 1 as well, when data is written into a memory area of the ECU 1, the data is transferred thereto via the communications activation device (COMCON). In the fifth embodiment, although the communications activation device (COMCON), as an added facility, is necessary in addition to the overhead in which communication is activated each time data is referred to or written, there is an advantage that since the T12 programs of the ECUs 1 and 2 are exactly the same, there is no need to perform program modifications for use in the ECU 2.

Symbols are briefly described as follows:

ECU . . . Electronic control unit, ROM . . . Read-only memory, RAM . . . Random-access memory, CPU . . . Central processing unit, COM . . . Communications device, T11, T12 . . . Tasks, I/O . . . Input/output device.

What is claimed is:

1. A distributed control system with a plurality of controllers connected to a network, each of the controllers including an input/output device, a memory device, a CPU, and a communications device, and executing a plurality of tasks in a distributed condition, wherein, between a first controller and second controller connected to the network, the first controller performs the functions of:
entering data from the input device into a memory area;
conducting arithmetic operations on a control task by using internal data of the memory device;
outputting arithmetic results to an output device;
transferring the context that includes, in addition to the internal data of the memory device, general-purpose register information, status register information, and other information, to the second controller; and
storing into the memory device the data transferred from the second controller; and
the second controller performs the functions of:
memorizing the data transferred from the first controller;
conducting arithmetic operations on another control task by using data of the memory device; and
transferring arithmetic results to the first controller.

2. The distributed control system according to claim 1, wherein the first controller retains information on a controller which functions to undertake, on behalf of the first controller, the arithmetic function for the control task that the first controller itself is to execute.

3. The distributed control system according to claim 2, wherein the first controller, after judging that the control task that the first controller itself is to execute cannot be processed within a required deadline, makes a processing request to the controller that functions to undertake the arithmetic function for the control task on behalf of the first controller.

4. The distributed control system according to claim 3, wherein the first controller, after judging that the control task that the first controller itself is to execute cannot be processed within the required deadline, makes a processing request to, and in accordance with the order of priority that is set up for, the controller that functions to undertake the arithmetic function for the control task on behalf of the first controller.

5. The distributed control system according to claim 4, wherein:
the controller requested from the first controller to undertake the arithmetic function for the control task on behalf of the first controller judges whether the control task can be executed, notifies judgment results to the first controller;
the first controller, when notified that the execution can be completed within a required time, sends an execution request to the controller requested to operate on behalf of the first controller; and
the controller requested to operate on behalf of the first controller waits for the execution request therefrom and then executes the control task.

6. The distributed control system according to claim 5, wherein, when there is no reply within a required time from the controller requested from the first controller to undertake the arithmetic function for the control task on behalf of the first controller, or when notified that the control task cannot be executed, the first controller requests the undertaking of the arithmetic function for the control task, to a controller other than the controller that was first requested to operate on behalf of the first controller.

7. The distributed control system according to claim 5, wherein, when the execution request is made within the required time from the first controller notified that the control task can be executed, the controller requested from the first controller to undertake the arithmetic function for the control task on behalf of the first controller executes the control task, and when the execution request is not made within the required time, the controller requested to operate on behalf of the first controller ignores the arithmetic function for the control task whose processing has been requested, and returns to the requested controller's own normal operational sequence.

8. The distributed control system according to claim 5, wherein:
the controller requested from the first controller to undertake the arithmetic function for the control task on behalf of the first controller stores the data transferred therefrom and the context including the general-purpose register information, the status register information, and other information, into exactly the same reference address as a data reference address of the first controller; and
the controller requested to operate on behalf of the first controller accesses exactly the same reference address and executes processing.

9. The distributed control system according to claim 5, wherein:
the controller requested from the first controller to undertake the arithmetic function for the control task on behalf of the first controller stores the data transferred therefrom and the context including the general-purpose register information, the status register information, and other information, into a reference address different from a data reference address of the first controller; and
the controller requested to operate on behalf of the first controller accesses the different reference address via an address translator and executes processing.

10. A distributed control system with a plurality of controllers connected to a network, each of the controllers including an input/output device, a memory device, a CPU, and a communications device, and executing a plurality of tasks in a distributed condition, wherein, between a first controller and second controller connected to the network:
the first controller and the second controller retain, in the respective memory devices, at least one of the same programs as those concerned with control items specific to the first controller; and
the second controller executes at least one of the programs in accordance with an execution request from the first controller, introduces the data required for the execution of at least one of the programs, by receiving the data transferred from the first controller via the communications device and the network, and transfers execution results to the first controller via the communications device and the network.

11. The distributed control system according to claim 10, wherein the first controller, after judging that the control task that the first controller itself is to execute cannot be processed within a required deadline, makes a processing request to the controller that functions to undertake the arithmetic function for the control task on behalf of the first controller.

12. The distributed control system according to claim 11, wherein the first controller, after judging that the control task that the first controller itself is to execute cannot be processed within the required deadline, makes a processing request to, and in accordance with the order of priority that is set up for, the controller that functions to undertake the arithmetic function for the control task on behalf of the first controller.

13. The distributed control system according to claim 12, wherein:
the controller requested from the first controller to undertake the arithmetic function for the control task on behalf of the first controller judges whether the control task can be executed, notifies judgment results to the first controller;
the first controller, when notified that the execution can be completed within a required time, sends an execution request to the controller requested to operate on behalf of the first controller; and
the controller requested to operate on behalf of the first controller waits for the execution request therefrom and then executes the control task.

14. The distributed control system according to claim 13, wherein, when there is no reply within a required time from the controller requested from the first controller to undertake the arithmetic function for the control task on behalf of the first controller, or when notified that the control task cannot be executed, the first controller requests the undertaking of the arithmetic function for the control task, to a controller other than the controller that was first requested to operate on behalf of the first controller.

15. The distributed control system according to claim 13, wherein, when the execution request is made within the required time from the first controller notified that the control task can be executed, the controller requested from the first controller to undertake the arithmetic function for the control task on behalf of the first controller executes the control task, and when the execution request is not made within the required time, the controller requested to operate on behalf of the first controller ignores the arithmetic function for the control task whose processing has been requested, and returns to the requested controller's own normal operational sequence.
